(19) United States
(12) Patent Application Publication
(10) Pub. No.: US 2014/0208005 A1
(43) Pub. Date: Jul. 24, 2014

(54) System, Method and Computer-Readable Medium for Providing Selective Protection and Endurance Improvements in Flash-Based Cache

(71) Applicant: LSI Corporation, San Jose, CA (US)

(72) Inventors: Horia Simionescu, Foster City, CA (US); Anant Baderdinni, Lawrenceville, GA (US); Luca Bert, Cumming, GA (US)

(73) Assignee: LSI Corporation, San Jose, CA (US)

(21) Appl. No.: 14/071,702

(22) Filed: Nov. 5, 2013

Related U.S. Application Data
(60) Provisional application No. 61/755,254, filed on Jan. 22, 2013.
(60) Provisional application No. 61/895,250, filed on Oct. 24, 2013.

(51) Int. Cl. G06F 12/02

(52) U.S. Cl. CPC G06F 12/0246
USPC 711/103

(57) ABSTRACT

A cache controller includes a cache memory distributed across multiple solid-state storage units in which cache line fill operations are applied sequentially in a defined manner and write operations are protected by a RAID-5 (striping plus parity) scheme upon a stripe reaching capacity. The cache store is responsive to data from a storage controller managing a primary data store. The cache store arranges the data differently based on the origin or type of data received at the cache interface. Line fill operations are placed in the cache memory without generating and storing corresponding parity information. When a sufficient number of write operations fill strips that constitute a full stripe are present in cache store, a corresponding parity strip is generated and stored in a strip location designated for storage of the parity information.

### TECHNICAL FIELD

The invention relates generally to data storage systems and, more specifically, to data storage systems employing a Flash-memory based data cache.

### BACKGROUND

Some conventional computing systems employ a non-volatile memory device as a block or file level storage alternative for slower data storage devices (e.g., a magnetic disk storage medium, an optical disk storage medium or one or more data storage devices accessible via a network) to improve performance of the computing system and/or applications executed by the computing system. In this respect, because input/output (I/O) operations can be performed significantly faster to some non-volatile memory devices (hereinafter a “cache device” for simplicity) than from or to a relatively slower storage device, use of the cache device provides opportunities to significantly improve the rate of I/O operations.

For example, in the system illustrated in FIG. 1, a data storage manager 10 controls a storage array 12 in a manner that enables reliable data storage. A host (computer) system 14 stores data in and retrieves data from storage array 12 via data storage manager 10. That is, a processor 16, operating in accordance with an application program or APP 18, issues requests for writing data to and reading data from storage array 12. Although for purposes of clarity host system 14 and data storage manager 10 are depicted in FIG. 1 as separate elements, it is common for a data storage manager 10 to be physically embodied as a card that plugs into a motherboard or backplane of such a host system 14.

Such systems may cache data based on the frequency of access to certain data stored in the data storage devices 24, 26, 28 and 30 of storage array 12. This cached or “hot” data, e.g., element A, is stored in a cache memory module 22 of the flash-based memory device 15. The element A can be identified at a block level or file level. Thereafter, requests issued by applications, such as APP 18, for the “hot” data are serviced by the flash-based memory device 15, rather than the storage media in the relatively slower storage array 12. Such conventional data caching systems are scalable and limited only by the capacity of the flash-based storage device 15.

It is also known that many application workloads benefit further when cache memory is used in write back mode. Write back mode is a storage method in which data is written into the cache every time a change occurs, but is written into a corresponding location in main memory, such as the storage array 12, at specified intervals or under certain conditions. When a data location is updated in write back mode, the data in the cache is fresh, and the corresponding data in the main memory, which no longer matches the data in the cache, is deemed stale. If a request for stale data in the main memory arrives from an application program, the cache controller either updates the data in the main memory before permitting the host application to access the data or the cache controller responds to the data request with the fresh data from the cache.

When cache stored data is held in write back mode the cache store needs to be protected from data loss. This can be accomplished through cache redundancy. However, the relatively high cost of cache memory devices makes it prohibitively expensive to provide redundant cache stores. Any redundancy provided by a more expensive storage medium reduces the total data storage capacity available. In light of the relatively higher cost per data storage capacity and the desire to maximize the effectiveness of the cache store, some conventional designs not only selectively decide what data should be cached, these designs further selectively decide what data in the cache should be protected by redundant storage.

For example, as indicated in FIG. 1, a separate and distinct cache memory module 21 in communication with the data storage manager 10 may temporarily cache data element B before and or during processing steps configured to reliably distribute data across the storage elements 24, 26, 28 and 30 of storage array 12.

In addition to the described design considerations, the circuit architecture of commonly deployed Flash-based memory elements must be taken into consideration to deploy effective systems and methods that adequately protect the contents of a cache store until such time that the cache can be written to the more economical data storage medium.

Concerning circuit architecture, Flash memory is an electronically erasable programmable read only memory (EEPROM). Flash memory is non-volatile in that it will maintain stored digital values after power is removed from the device. Flash memory is arranged in a grid of columns and rows with a data storage cell that includes two transistors at each intersection. A word line is coupled to a control gate supported by the first transistor. A bit line is coupled to a floating gate supported by the second transistor. When the electrical charge passing through the floating gate is above a threshold the cell has a value of 1. When the electrical charge passing through the floating gate falls below the threshold the cell has a value of 0. A blank Flash memory has all of the gates fully open, giving each cell a value of 1. Flash memory selectively applies an electric field to specified regions or blocks to erase the cells within the specified region. It is only after cells have been erased that data can be written to the cells. The erase and program operations inherently cause degradation in an oxide layer that isolates the floating gate from the control gate. This is the reason that Flash-based memory has a finite lifespan. Consequently, many conventional flash-memory type controllers manage the write operations to flash-memory to balance or distribute the erase and write cycles across the entire storage capacity of the flash memory device. However, many of these wear leveling algorithms and techniques will perform additional erasures and write operations that can prematurely reduce the useful life of storage locations in the Flash memory device.

A redundant array of inexpensive (or independent) disks (RAID) is a common type of data storage system that addresses the reliability of stored data by enabling recovery from the failure of one or more storage devices. It is known to incorporate data caching in a RAID system. In the system illustrated in FIG. 1, data storage manager 10 includes a RAID processing system 20 that caches data in units of blocks, which can be referred to as read cache blocks (RCBs) and write cache blocks (WCBs). The WCBs comprise data that host system 14 sends to the data storage manager 10 as part of requests to store the data in storage array 12. In response to such a write request from host system 14, data storage manager 10 caches or temporarily stores a WCB in one or more cache memory modules 21, then returns an acknowledgement message to host system 14. At some later point in time, data storage manager 10 transfers the cached WCB (typically along with other previously cached WCBs) to storage array 12. The RCBs comprise data that data storage manager 10 has frequently read from storage array 12 in response to read requests from host system 14. Caching frequently requested data is more efficient than reading it from storage array 12 each time host system 14 requests the corresponding data.

RAID level 5 uses striping in combination with distributed parity. In order to implement distributed parity, all but one of the physical disk drives (PDDs) must be present for the system to operate. Failure of any one of the PDDs necessitates replacement of the PDD. However, failure of a single one of the PDDs does not cause the system to fail. Upon failure of one of the PDDs, subsequent read requests can be satisfied by determining the entirety of the previously stored information from the distributed parity such that the PDD failure is masked from the end user. If a second PDD fails, the storage system will suffer a loss of data. Thus, before a first failed PDD is replaced and the appropriate data is completely reconstructed, the storage system is vulnerable to potential data loss.

In the system illustrated in FIG. 1, data storage manager 10 includes a RAID processing system 20 that stores data in units of blocks or strips across the PDDs 24, 26, 28, 30, in storage array 12. The RAID processing system 20 includes a processor 32 and a memory 34. The processor 32 works in conjunction with the logic stored in the memory 34 and the data within each of the strips A, B and C to generate a parity block (labeled P_ABC) generated by performing an Exclusive-OR or XOR logic operation on the data within the strips A, B, and C. In accordance with a RAID level 5 data protection scheme, parity blocks are distributed across the PDDs 24, 26, 28, 30.

### SUMMARY

A cache using an array of flash-based or other solid state memory elements employs a novel method that minimizes the cost of performing parity computations while reliably protecting cache lines through selective spatial data arrangement and full stripe write operations. As a result, the life of the improved cache memories can be significantly extended. In addition, parity is calculated after a data capacity corresponding to a full-stripe write is readily available to avoid the overhead associated with parity computations and intermediate write operations that use a read-modify write approach.

An example embodiment of a method for operating a cache memory supported by solid-state data storage modules includes the steps of defining a layout for distributing data in a cache memory supported by N solid-state memory elements, where N is an integer; initializing, in a cache controller, a line fill count and a write count; receiving a data block in a cache interface, the contents of the data block designated for storage in the cache memory; determining, in a cache controller, if the content of the data block is presently stored in a primary data store coupled to the cache interface or if the content is from a host system in anticipation of a subsequent transfer to the primary data store; and when the content of the data block is presently stored in the primary data store, storing the data block in the cache memory in response to the line fill count and incrementing the line fill count, otherwise, storing the data block in the cache memory in response to the write count and incrementing the write count.

An example embodiment of a data storage system includes a cache memory and a controller. The cache memory is coupled to the controller and supported by a number of solid state storage modules. The controller includes logic that manages data transfers to and from the cache memory. The data transfers include line fill operations that are distributed in a defined manner among the N solid-state memory modules.

An example embodiment of a computer-readable medium has stored thereon, in computer executable non-transitory form, instructions that, when executed on a processing system of a data storage controller, direct the data storage controller to identify when a data block designated for storage in a cache memory is presently stored in a primary data store coupled to the cache memory and locate such data in the cache memory in response to a line fill count. Otherwise, when the data designated for storage in the cache memory is not presently stored in the primary memory locate such data in the cache memory in response to a write count. Such that data stored in the cache memory is placed in a logically sequential order within each respective solid-state storage module.

These and other features and advantages of the present systems and methods will become apparent from the following description, drawings and claims.

### BRIEF DESCRIPTION OF THE DRAWINGS

FIG. 1 includes a block diagram that illustrates an embodiment of a conventional data storage system.

FIG. 2 includes a block diagram that illustrates an embodiment of an improved storage controller in a computing environment.

FIG. 3 includes a block diagram of an embodiment of a defined array supported by the flash-based memory elements in the cache store of FIG. 2.

FIG. 4 illustrates a block diagram of an embodiment of a defined array that supports the storage of a first data type from the storage controller of FIG. 2.

FIG. 5 illustrates a block diagram of an alternative embodiment of a defined array that supports the storage of the first data type from the storage controller of FIG. 2.

FIG. 6 illustrates a block diagram of an embodiment of a defined array that supports the storage of a second data type from the storage controller of FIG. 2.

FIG. 7 illustrates a schematic diagram of a series of data storage operations for storing data of the first type and the second type in the cache store of FIG. 2.

FIGS. 8A and 8B illustrate a flow diagram of a method for processing data with a storage controller.

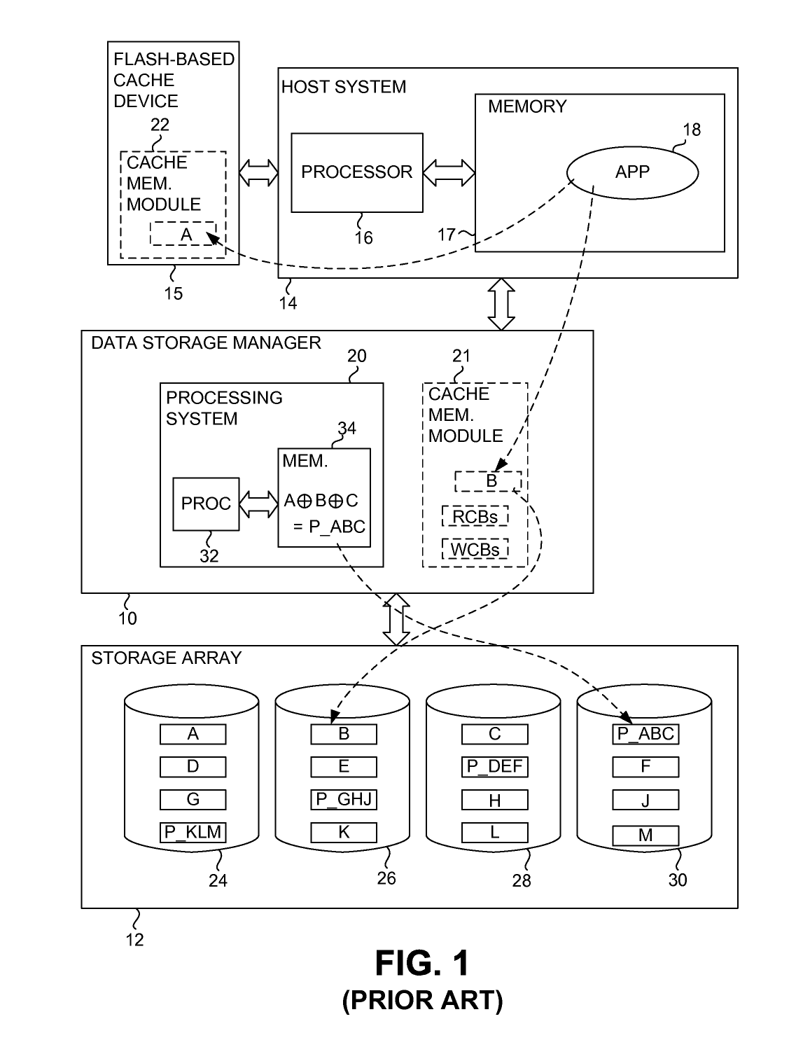

### DETAILED DESCRIPTION OF ILLUSTRATIVE EMBODIMENTS

In accordance with the improved storage systems, methods and computer-readable medium for providing selective cached data protection and endurance improvements for Flash-based cache storage elements, a cache or storage controller identifies whether the data sent to the cache has already been stored in a primary data store. Data previously stored in the primary data store that is frequently accessed is identified by one or more mechanisms as data that should be placed in the cache store where it can be accessed faster by a host system. Such data is already protected by the original copy in the primary data store and any data protection methodologies implemented by a storage controller managing the primary data store. When such data is forwarded by the storage controller to a cache store the data is segmented into storage blocks of a desired size and stored in accordance with associated storage locations in a defined array. These operations will be referred to as line fill operations. Data not previously stored in the primary data store and held in a write back mode is vulnerable to data loss as the data will be transferred from the cache store to the primary data store at a later time. Such data is unprotected as there is no copy in the primary data store until the data is transferred to the primary data store. When such data is forwarded by the storage controller to the cache store the data is segmented into the desired size and stored in accordance with storage locations identified by the defined array. These operations will be referred to as write operations. An incoming stream of data at the cache store interface may contain both data for line fill operations and data for write operations.

A cache store supported by an array of flash-based solid state memory elements or solid-state storage devices employs a novel method of distributing data in the cache store to dramatically reduce the number of erase cycles applied to the separate data elements. In contrast with conventional systems that write data randomly to the physical solid state storage elements and that maintain a logical map to correctly identify data stored within the storage elements, the present cache interface writes data sequentially to each individual flash-based storage element or solid-state storage element supporting the cache store. As will become apparent in view of the illustrated embodiments the segmented cache lines may be distributed in a number of different strip sequences within any particular stripe as long as the data is written sequentially to each individual flash-based storage element. Thus, the order of data segments associated with a line fill operation may appear random when in fact, as long as the sequence is defined by a storage array and sequentially repetitious within each flash-based storage element, data in the cache store is retrievable and will extend the useful life of the storage elements by reducing the number of erasures required to write data to the cache store when compared to conventional flash-based storage methods.

In addition, write operations are augmented at select times with a parity strip calculation to protect the data associated with write operations from potential data loss. The parity strip calculation and corresponding storage of the parity strip information in the cache store as identified by a defined array is performed only after a full stripe of write operation data is available in the cache store. Accordingly, the improved storage systems minimize the overhead cost of performing parity computations while reliably protecting data associated with write operations through selective spatial data arrangement coupled with selective parity calculation and insertion in the cache store. Thus, the improved systems and methods avoid the overhead associated with parity computations and intermediate write operations to a cache store that implement a read-modify write approach.

The cache storage layout or defined array includes a consistent data segment size in bytes that is applied to each logically addressable strip. The specific data segment size is selected in an effort to align data transfers with the input/output interface of the cache store. In one example embodiment, a data segment size of 64 kbytes is used. It should be recognized and understood that other data segment sizes including those with less than 64 kbytes or more than 64 kbytes could be implemented as may be desired.

While the addition of the parity strip introduces a capacity cost, such storage layouts permit the storage controller to arrange data in a cache and provide for data protection from permanent loss. In addition, by arranging data from line fill operations and write operations such that each strip or block of information distributed across the N separate memory modules of the cache store in accordance with a select and ordered sequence for each separate memory module enables the storage controller to avoid complex serialization and remapping that would otherwise be required when using conventional methods for randomly writing data to solid state storage modules.

Under certain circumstances the storage controller may dictate a write operation to the cache store that is smaller than the capacity of the full stripe write. Under such conditions, the storage controller may adjust the defined array on the fly to identify a modified parity calculation before the data associated with the capacity of a full stripe arrives at the cache interface. For example, under some circumstances it is possible that the data stream that arrives at the cache interface includes only a small portion of data associated with write operations before receiving a relatively longer sequence of data that is stored in the primary data store. When this is the case, the storage controller may perform a partial parity calculation over less than the number of strips in a full stripe to protect the data from permanent loss.

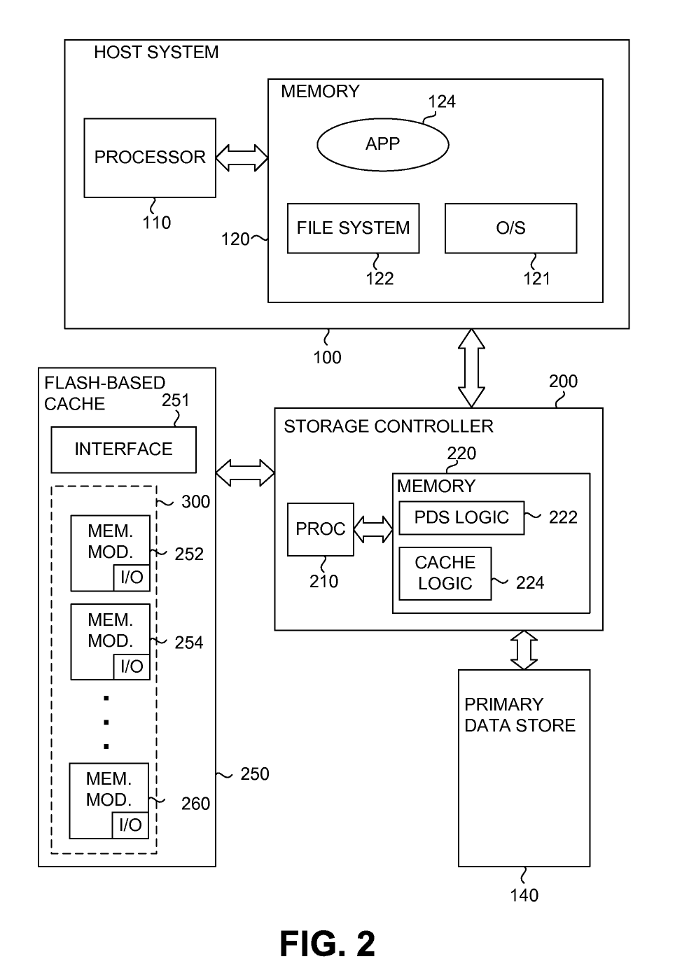

Attention is now directed to the illustrated embodiments of the improved storage system, storage controller, distributed storage layouts and their use with a cache store as shown in FIGS. 2-8B. FIG. 2 includes a block diagram that illustrates an embodiment of an improved storage controller 200 in a computing environment that includes a host system 100, a cache store 250 and a primary data store 140.

Host system 100 communicates with the storage controller 200 which in turn stores data in primary data store 140. The flash-based cache element or cache store 250 is used by the storage controller 200 to reduce the time or latency for retrieving data from the primary data store 140. In preferred embodiments, the contents of the cache store 250 are not exposed to the application level programs executing in the host system 100. In these preferred embodiments, the storage controller 200 alone is responsible for managing the cache store 250.

The host system 100 includes at least one processor 110 in communication with a memory element 120 via a communication bus represented by a two-way arrow. The memory 120 includes an operating system 121, which manages a file system 122 and that also includes application software and associated data represented in the illustration as APPs 124. One or more of APP(s) 124 and/or the file system 122 under the direction of the operating system 121 communicate with the storage controller 200 to store files, programs, or other information in an organized way in the primary data store 140.

From the perspective of the host 100, data stored in the primary data store 140 appears as one or more logical data volumes even though the data may be distributed across a set of hard disk drives. Stated another way, the host 100 is aware of one or more logically separated storage locations or letter labeled drives.

Host 100 is a computing device such as a server or other computer that functions in accordance with one or more operating system(s) (O/S) 121 and is capable of executing one or more applications, such as APP 124. Host 100 further includes an interface (not shown) that connects the APP 124 and the O/S 121 to the data volume(s) in the primary data store 140. The host 100 may include one or more additional interfaces such as human-to-machine interfaces to support configuration and interaction with an operator.

The storage controller 200 includes one or more processors such as the processor 210 and the memory element 220. The processor 210 and the memory element 220 communicate via a bus illustrated with a two-way arrow. The memory 220 includes primary data store or PDS logic 222 (e.g., one or more programs or routines) for managing data transfers between the primary data store 140 and the host system 100.

The processor 210 is a hardware device for executing firmware and or software particularly PDS logic 222 and cache logic 224 stored in the memory 220, which can be supported by a read-only memory element. The processor 210 can be constructed in accordance with a custom made or a commercially available integrated-circuit based processor, or can even be a standalone central processing unit (CPU); an auxiliary processor among several processors associated with PCI-E peripheral device; a semiconductor-based microprocessor (in the form of a microchip or chip set); or generally any device for executing software instructions stored in the memory 220. The processor 210, in accordance with the cache logic 224, manages data transfers between the cache store 250 and the storage controller 200. The data transfers as managed by the storage controller 200 include successive line fill operations to designated solid-state storage devices distributed among the N solid-state storage elements in a defined manner. The data transfers further include write operations that include information that will later be written to the primary data store 140.

Although for purposes of clarity host system 100 and the storage controller 200 are depicted in FIG. 2 as separate elements, it is common for storage controllers to be physically embodied as an integrated circuit card that plugs into a motherboard or backplane (not shown) of such a host system 100.

The primary data store 140 may include one or more hard-disk drives. The one or more hard-disk drives may include a set of magnetic platters that are modified by read/write heads that are controlled via an electro-mechanical control system. When data is to be written to the hard-disk drive a current is controllably applied to the write heads to adjust the magnetic poles in discrete tracks arranged along the magnetic platters as the platters rotate. When data is to be read from the hard-disk drives read heads are controllably placed over the tracks as the platters rotate. The read heads generate a signal that is responsive to changes in a magnetic field as the platters rotate. The time it takes to controllably position the read/write heads and the time it takes to communicate the data to or from the interface to the hard-disk drive contribute to the overall responsiveness of the one or more hard-disk drives. While there are a number of techniques for minimizing the time it takes to read or write data and process the same so that the data can be made available to the host system 100 from the primary data store 140, it is typically the case that data can be written to and read from a flash-based memory module significantly faster than when these similar input/output or I/O operations are performed with a hard-disk drive or a system of hard-disk drives.

Accordingly, the storage controller 200 is provided for identifying or acting in response to the identification of “hot” or frequently accessed data that is already stored in the primary data store 140. The storage controller 200 acting in response to such an indication, will store a copy of the hot data in the cache store 250 so that future requests for the information from the host system 100 can be fulfilled much more quickly by the combination of the cache store 250 and the storage controller 200 than by the combination of the storage controller 200 and the primary data store 140.

The flash-based cache store 250 includes an interface 251 and a set of N memory modules, where N is an integer. In the illustrated embodiment, each of the N memory modules 252-260 includes or is supported by a dedicated I/O interface for transferring data to and from the integrated circuit elements therein that provide the addressable circuit locations for storing information. For embodiments that are expected to store only data that has been previously stored in the primary store 140, N may be as small as one. For embodiments that are expected to store data that is being stored in the cache store 250 until a later time when the data can be written to the primary store 140, N may be as small as three.

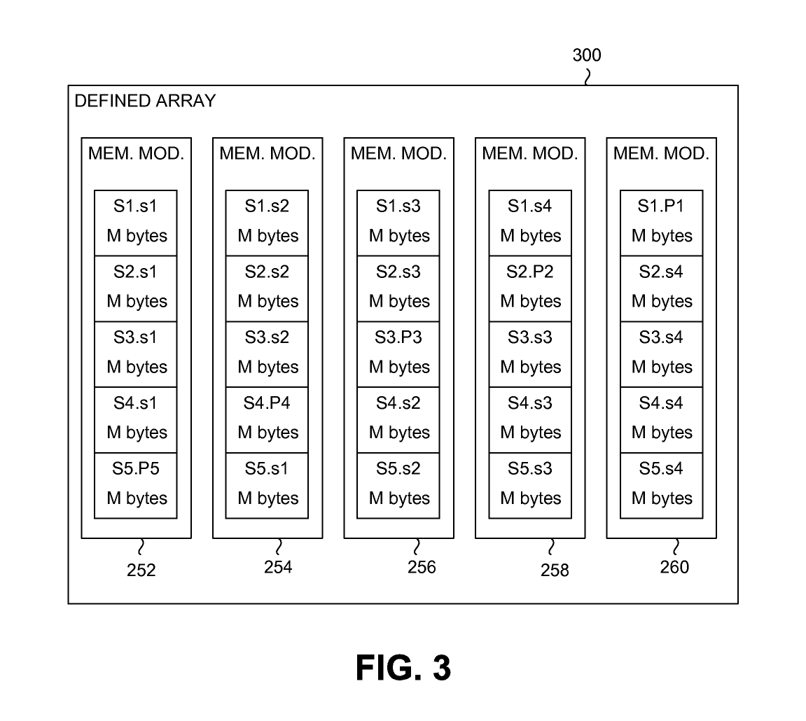

As will be explained in greater detail in association with FIGS. 3-7, the storage controller 200 working in conjunction with the interface 251 defines a cache storage array or a defined array 300 that distributes the segments of information into strips of equal capacity. The strips are arranged in sets or stripes across the N flash-based memory modules 252-260. The stripes further include a strip designated for the storage of a parity strip calculated by performing an XOR logic operation on the N−1 remaining strips of the stripe. As indicated above, the interface 251 is arranged with logic to selectively perform the parity calculation. In accordance with a preferred embodiment, the interface 251 performs the parity calculation only after each of the N−1 bits of the corresponding stripe have been populated with information from corresponding write operations.

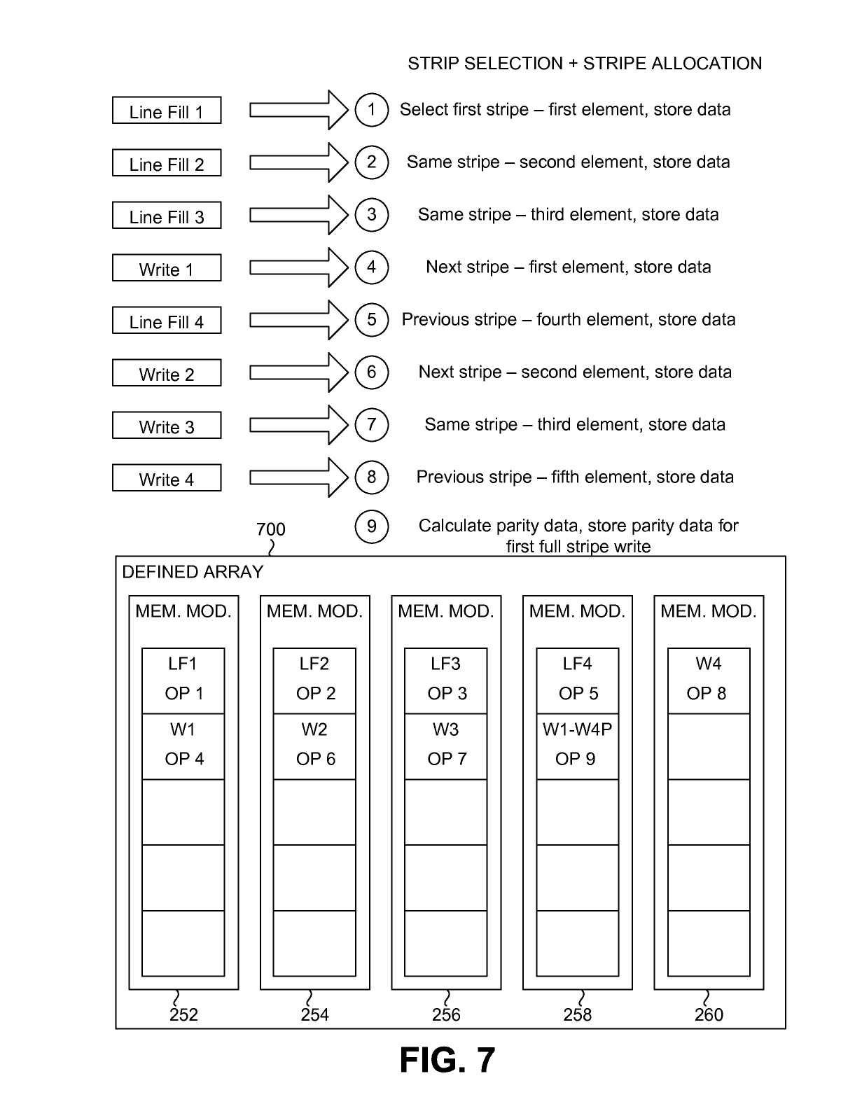

As will be explained in greater detail in association with FIG. 7, a data stream received at the interface 251 that contains information corresponding with only line fill operations does not require protection and no parity calculation is desired for stripes populated with such data. In contrast, when the data stream received at the interface includes information corresponding to write operations a parity calculation will be performed once write operations fill the strips of a stripe in the defined array and the results stored in the parity strip for the stripe. When both line fill and write operations are represented in the cache store 250, line fill operations will be stored in first stripe with write operations being stored in a subsequent stripe or vice-versa depending on which appears first at the interface 251. While no single stripe is designated or defined in the array for storage of a particular type of data, once a strip of the stripe receives data the remaining strips of the stripe will be used to store data of that same type as long as the data is written sequentially to each of the memory modules 252-260 supporting the cache store 250. Thus, data corresponding to write operations will be located in addressable strips arranged in stripes. While data corresponding to line fill operations will be located in different stripes from those populated with data corresponding to write operations.

The cache logic 224 and interface logic (not shown) that may support the interface 251 may be stored on a computer-readable medium in a non-transitory form. The executable instructions, operating parameters and/or data contained therein may be implemented in a non-volatile memory in one or both of the storage controller 200 and the flash-based cache 250.

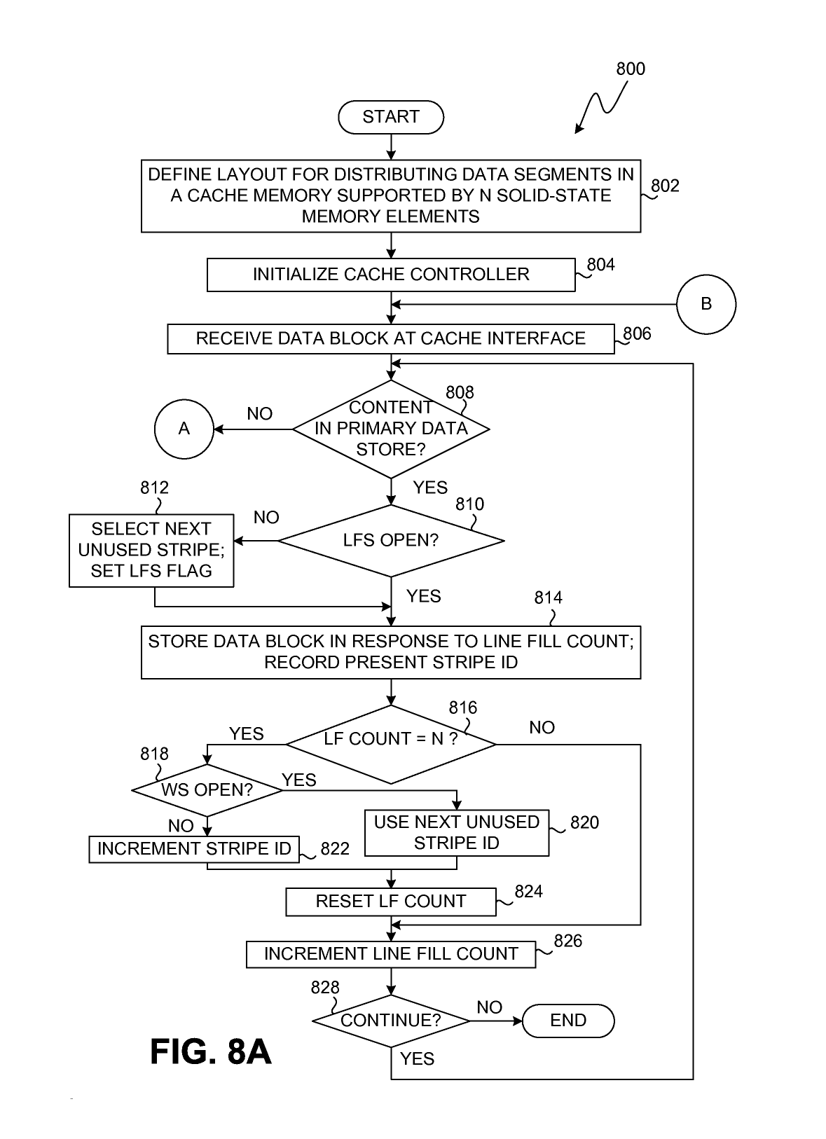

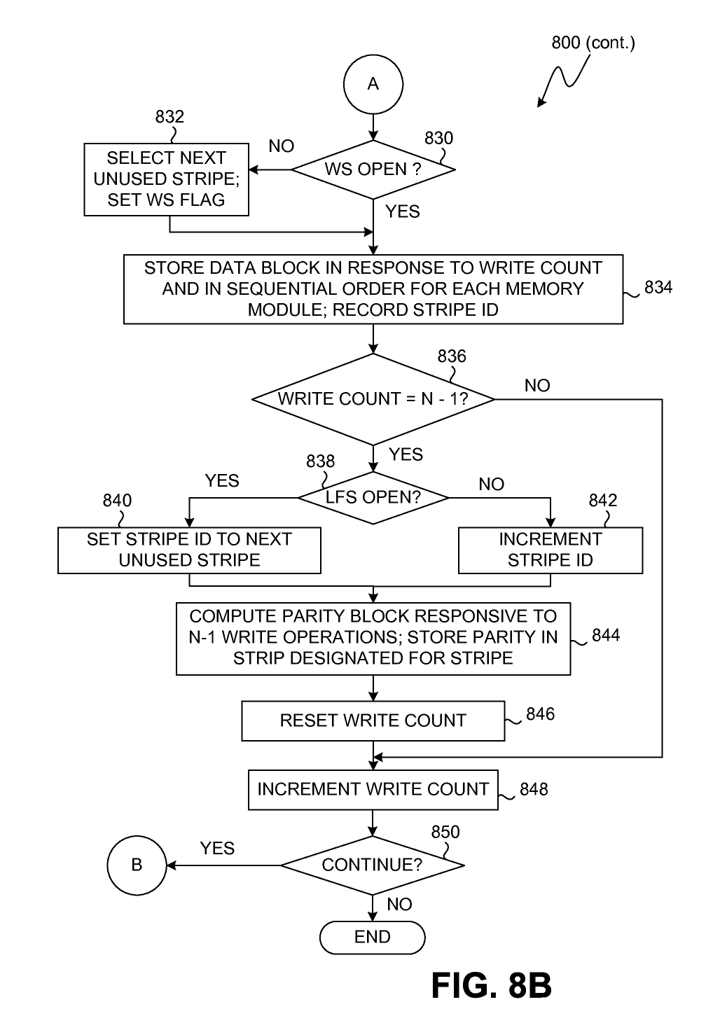

As will be explained in greater detail in association with the description of the flow diagram in FIGS. 8A and 8B, the storage controller may identify when a block of data designated for storage in the cache store 250 supported by N solid-state storage modules is presently stored in the primary data store 140. When such content arrives at the interface 251, the flash-based cache 250 will store such data in accordance with a defined array in one of the N memory modules. The interface 251 will locate the data block in the cache memory in response to a line fill count. Otherwise, the interface 251 will locate data received at the cache store 250 in response to a write count. As indicated, each data block is located in a logically sequential order within each respective solid-state storage module. As also indicated, strips that include data associated with write operations will be protected by a parity strip designated to store parity information for a stripe upon receipt of a N−1^{th} data block with data responsive to write block operations.

As indicated briefly above, data buffered by the storage controller 200 and forwarded to the interface 251 is segmented logically into blocks or strips of a predetermined size in bytes. The specific block or strip size may be selected to transfer data to the flash-based cache in desired amounts. By selecting a block or strip size in bytes that is an integer multiple of the dedicated I/O interface to the physical circuits of the flash-based memory modules, data to be transferred can be optimally aligned by the storage controller 200 to optimize data transfers to and from the flash-based cache store 250. In an example embodiment, the strip size is 64 kBytes. Strip sizes can be smaller or larger than 64 k Bytes. As erase blocks or regions in a flash-based memory module are generally much larger than 64 kBytes, the number of such erasures may be dramatically reduced by the present methods that write sequentially to each memory module to avoid the overhead associated with conventional systems that randomly write data to flash-based storage elements.

Although for purposes of clarity and description the flash-based cache 250 and the storage controller 200 are depicted in FIG. 2 as separate elements, it should be understood that the flash-based cache could be physically embodied in an improved storage controller (not shown). That is, the interface 251 and the N storage modules supporting a defined array 300 could be implemented in one or more integrated circuits within such an improved storage controller. To facilitate expansion of the storage capacity of the cache store, physical interfaces such as sockets can be arranged on one or more communication bus to permit the addition or integration of flash-based cache store modules with such an improved storage controller.

Although the illustrated embodiment includes a single host 100 and a single primary data store 140, it should be understood that the storage controller 200 and the flash-based cache store 250 can be adaptively scaled to support data transfers between additional hosts including virtual hosts and any number of desired data volumes supported by one or more primary data stores.

FIG. 3 includes a block diagram of an embodiment of a defined array 300 supported by the flash-based memory elements 252, 254, . . . , 260 in the cache store 250 of FIG. 2. As indicated in FIG. 3, the defined array 300 is supported by N separately addressable and otherwise independent data storage elements labeled “MEM. MOD.” or memory module. As indicated, the N separately data storage elements may be flash-based elements provided in one or more integrated circuits or separately addressable solid-state storage drives. Although the illustrated embodiment includes five such separately addressable data storage elements, arranged as memory module 252, memory module 254, memory module 356, memory module 258, and memory module 260, it should be understood that alternative embodiments with as few as three separately addressable data storage elements or with as many separately addressable data storage elements as may be required to achieve a desired total cache store capacity with a set of commonly available storage elements may be included in the defined array 300.

As further illustrated in FIG. 3, the memory module 252 is divided into a sequentially ordered series of blocks or strips each having a capacity of M bytes. The sequentially ordered series of blocks or strips include a first sub-element or strip labeled “s1” in a set of stripes labeled “S1-S4” with a fifth sub-element or parity strip labeled “S5.P5” providing a defined location for a parity strip associated with the corresponding strips in a fifth stripe.

The memory module 254 is similarly divided into a sequentially ordered series of strips having a capacity of M bytes. The set of ordered strips include a second sub-element or strip labeled “s2” in a set of stripes labeled S1, S2, S3, followed by a strip labeled “S4.P4” that provides a defined location for a parity strip associated with the corresponding strips of a fourth stripe and a strip labeled “s1” associated with the fifth stripe.

The memory module 256 is also divided into a sequentially ordered series of strips having a capacity of M bytes. The set of ordered strips include a third sub-element or strip labeled “s3” in a set of stripes labeled S1, S2, followed by a strip labeled “S3.P3” that provides a defined location for a parity strip associated with the corresponding strips of a third stripe (S3) and strips labeled “s2” associated with the fourth and fifth stripes thereafter.

Next, the memory module 258 is divided into a sequentially ordered series of strips having a capacity of M bytes. The set of ordered strips include a fourth sub-element or strip labeled “s4” in a set of stripes labeled S1, followed by a strip labeled “S2.P2” that provides a defined location for a parity strip associated with the corresponding strips of a second stripe (S2) and strips labeled “s3” associated with the third, fourth and fifth stripes thereafter.

Last, the memory module 260 is divided into a sequentially ordered series of strips having a capacity of M bytes. The set of ordered strips include a strip labeled “S1.P1” that provides a defined location for a parity strip associated with the corresponding strips of the first stripe followed by strips labeled “s4” associated with the second through fifth stripes.

When the capacity in bytes of the memory module exceeds the product of the number of stripes and M bytes, this pattern may be repeated across a desired number of stripes until the assigned storage capacity of the separately addressable memory modules across the identified stripes in total reaches a desired capacity of the cache store or the capacity of the N memory modules is exhausted.

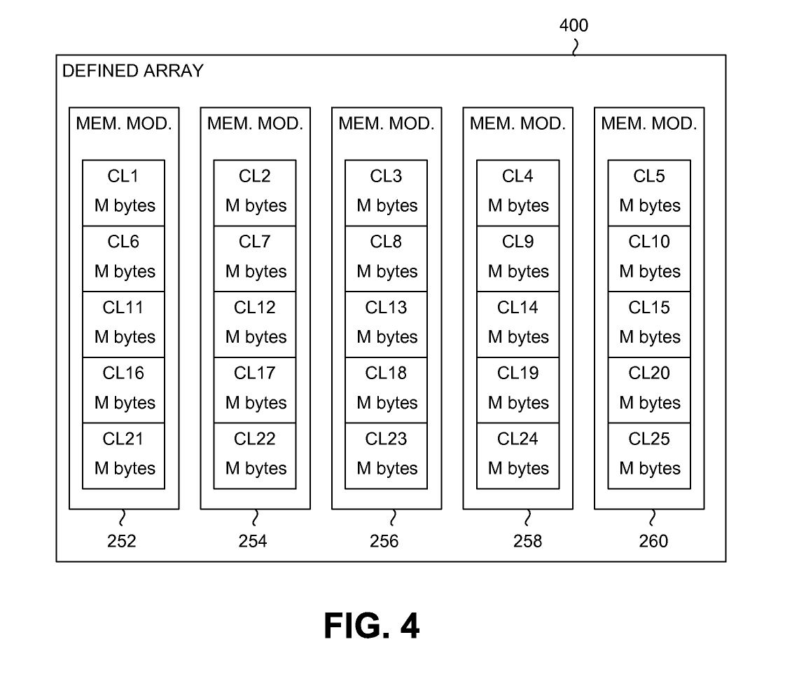

FIG. 4 illustrates a block diagram of an embodiment of a defined array 400 that supports the storage of line fill operations from the storage controller 200 of FIG. 2. As indicated in FIG. 4, the defined array 400 is supported by N separately addressable and otherwise independent data storage elements labeled “MEM. MOD.” or memory module. As indicated, the N separately data storage elements may be flash-based elements provided in one or more integrated circuits or separately addressable solid-state storage drives. Although the illustrated embodiment includes five such separately addressable data storage elements, arranged as memory module 252, memory module 254, memory module 256, memory module 258, and memory module 260, it should be understood that alternative embodiments with as few as two separately addressable data storage elements or with as many separately addressable data storage elements as may be required to achieve a desired total cache store capacity with a set of commonly available storage elements may be included in the defined array 400.

As further illustrated in FIG. 4, the memory module 252 is divided into a sequentially ordered series of blocks or strips each having a capacity of M bytes. The sequentially ordered series of blocks or strips include a first sub-element or strip labeled “CL1” followed by “CL6,” “CL11,” CL16,” and “CL21.” While not arranged in a straight sequence such as 1, 2, 3, 4, 5, the cache lines in this first memory module 252 of the defined array 400 are in a sequential order in that CL6 follows CL1, CL11 follows CL6, CL16 follows CL11 and CL21 follows CL16. Note that no parity stripe is identified when only cache lines are written to the cache store 250.

The memory module 254 is similarly divided into a sequentially ordered series of blocks or strips each having a capacity of M bytes. The sequentially ordered series of blocks or strips include a first sub-element or strip labeled “CL2” followed by “CL7” “CL12,” CL17,” and “CL22.” While not arranged in a straight sequence such as 1, 2, 3, 4, 5, the cache lines in memory module 254 of the defined array 400 are in a sequential order in that CL7 follows CL2, CL12 follows CL7, CL17 follows CL12 and CL22 follows CL17.

The memory module 256 is also divided into a sequentially ordered series of blocks or strips each having a capacity of M bytes. The sequentially ordered series of blocks or strips include a first sub-element or strip labeled “CL3” followed by “CL8” “CL13,” CL18,” and “CL23.” While not arranged in a straight sequence such as 1, 2, 3, 4, 5, the cache lines in memory module 256 of the defined array 400 are in a sequential order in that CL8 follows CL3, CL13 follows CL8, CL18 follows CL13 and CL23 follows CL18.

The memory module 258 is divided into a sequentially ordered series of blocks or strips each having a capacity of M bytes. The sequentially ordered series of blocks or strips include a first sub-element or strip labeled “CL4” followed by “CL9” “CL14,” CL19,” and “CL24.”

Lastly, memory module 260 is divided into a sequentially ordered series of blocks or strips each having a capacity of M bytes. The sequentially ordered series of blocks or strips include a first sub-element or strip labeled “CL5” followed by “CL10” “CL15,” CL20,” and “CL25.”

When the capacity in bytes of the memory module 260 exceeds the product of the number of cache lines and M bytes, this pattern may be repeated across a desired number of sub-elements or blocks until the assigned storage capacity of the separately addressable memory modules 252-260 in total reaches a desired capacity of the cache store or the capacity of the N memory modules is exhausted.

From the above, it is clear that data is segmented and arranged within each of the separate memory modules 252-260 both sequentially and in a repetitive manner. In the illustrated embodiment, each subsequent segment in each of the separate memory modules 252-260 is designated for the storage of data associated with every fifth segment of M bytes from a data stream of line fill operations received at the cache store interface.

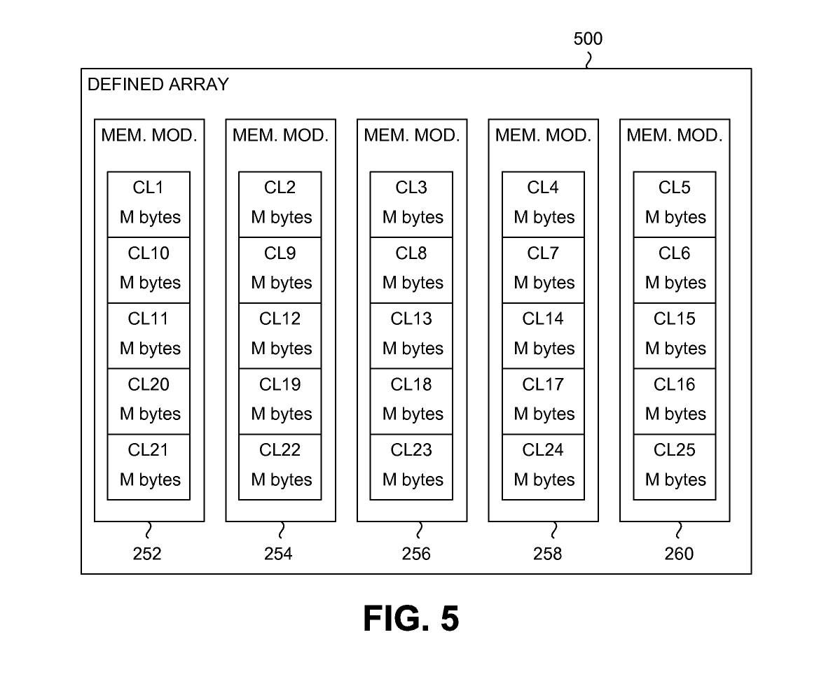

FIG. 5 illustrates a block diagram of an alternative embodiment of a defined array 500 that supports the storage of the first data type from the storage controller 200 of FIG. 2. As indicated in FIG. 5, the defined array 500 is supported by N separately addressable and otherwise independent data storage elements labeled “MEM. MOD.” or memory module. As indicated, the N separately data storage elements may be flash-based elements provided in one or more integrated circuits or separately addressable solid-state storage drives. Although the illustrated embodiment includes five such separately addressable data storage elements, arranged as memory module 252, memory module 254, memory module 256, memory module 258, and memory module 260, it should be understood that alternative embodiments with as few as two separately addressable data storage elements or with as many separately addressable data storage elements as may be required to achieve a desired total cache store capacity with a set of commonly available storage elements may be included in the defined array 500.

As further illustrated in FIG. 5, the memory module 252 is divided into a sequentially ordered series of blocks or strips each having a capacity of M bytes. The sequentially ordered series of blocks or strips include a first sub-element or strip labeled “CL1” followed by “CL10,” “CL11,” CL20,” and “CL21.” While not arranged in a straight sequence such as 1, 2, 3, 4, 5, the cache lines in this first memory module 252 of the defined array 500 are in a sequential order in that CL10 follows CL1, CL11 follows CL10, CL20 follows CL11 and CL21 follows CL20. Note that no parity stripe is identified when only cache lines are written to the cache store 250.

The memory module 254 is similarly divided into a sequentially ordered series of blocks or strips each having a capacity of M bytes. The sequentially ordered series of blocks or strips include a first sub-element or strip labeled “CL2” followed by “CL9” “CL12,” CL19,” and “CL22.” While not arranged in a straight sequence such as 1, 2, 3, 4, 5, the cache lines in memory module 254 of the defined array 500 are in a sequential order in that CL9 follows CL2, CL12 follows CL9, CL19 follows CL12 and CL22 follows CL19.

The memory module 256 is also divided into a sequentially ordered series of blocks or strips each having a capacity of M bytes. The sequentially ordered series of blocks or strips include a first sub-element or strip labeled “CL3” followed by “CL8” “CL13,” CL18,” and “CL23.” While not arranged in a straight sequence such as 1, 2, 3, 4, 5, the cache lines in memory module 256 of the defined array 500 are in a sequential order in that CL8 follows CL3, CL13 follows CL8, CL18 follows CL13 and CL23 follows CL18.

The memory module 258 is divided into a sequentially ordered series of blocks or strips each having a capacity of M bytes. The sequentially ordered series of blocks or strips include a first sub-element or strip labeled “CL4” followed by “CL7” “CL14,” CL17,” and “CL24.”

Lastly, memory module 260 is divided into a sequentially ordered series of blocks or strips each having a capacity of M bytes. The sequentially ordered series of blocks or strips include a first sub-element or strip labeled “CL5” followed by “CL6” “CL15,” CL16,” and “CL25.”

When the capacity in bytes of the memory module 260 exceeds the product of the number of cache lines and M bytes, this pattern or other patterns may be repeated across a desired number of sub-elements or strips until the assigned storage capacity of the separately addressable memory modules 252-260 in total reaches a desired capacity of the cache store or the capacity of the N memory modules is exhausted.

From the above, it is clear that data is segmented and arranged within each of the separate memory modules 252-260 both sequentially and in a repetitive manner for each of the respective memory modules. In the illustrated embodiment, after storage of the first M bytes associated with a line fill operation in the first segment, eight other segments are distributed across the remaining elements before the ninth subsequent segment of M bytes is stored in memory module 252. The next subsequent segment of M bytes is stored immediately thereafter in the next sequential segment in memory module 252. This alternating pattern of data segment storage may be repeated until the storage capacity of memory module 252 is entirely filled with data associated with line fill operations.

In the illustrated embodiment, after storage of the second M bytes associated with a line fill operation in the first segment of memory module 254, six other segments are distributed across memory modules 256-260 before the seventh subsequent segment of M bytes is stored in the next sequentially ordered segment of M bytes in memory module 254. The next two subsequent segments of M bytes are stored thereafter in memory module 252. This alternating pattern of data segment storage may be repeated until the storage capacity of memory module 254 is entirely filled with data associated with line fill operations.

In the present embodiment, after storage of the third segment of M bytes associated with a line fill operation in the first segment of memory module 256, four other segments are distributed across memory modules 258-260 before the fifth subsequent segment of M bytes is stored in the next sequentially ordered segment of M bytes in memory module 256. The next four subsequent segments of M bytes are stored thereafter in memory modules 252-254. This alternating pattern of data segment storage may be repeated until the storage capacity of memory module 256 is entirely filled with data associated with line fill operations.

In the illustrated embodiment, after storage of the fourth segment of M bytes associated with a line fill operation in the first segment of memory module 258, two other segments are distributed across memory module 260 before the third subsequent segment of M bytes is stored in the next sequentially ordered segment of M bytes in memory module 258. The next six subsequent segments of M bytes are stored thereafter in memory modules 252-256. This alternating pattern of data segment storage may be repeated until the storage capacity of memory module 258 is entirely filled with data associated with line fill operations.

In the illustrated embodiment, after storage of the fifth segment of M bytes associated with a line fill operation in the first segment of memory module 260, the next subsequent segment of M bytes is stored in the next sequentially ordered segment of M bytes in memory module 260. The next eight subsequent segments of M bytes are stored thereafter in memory modules 252-258. This alternating pattern of data segment storage may be repeated until the storage capacity of memory module 260 is entirely filled with data associated with line fill operations.

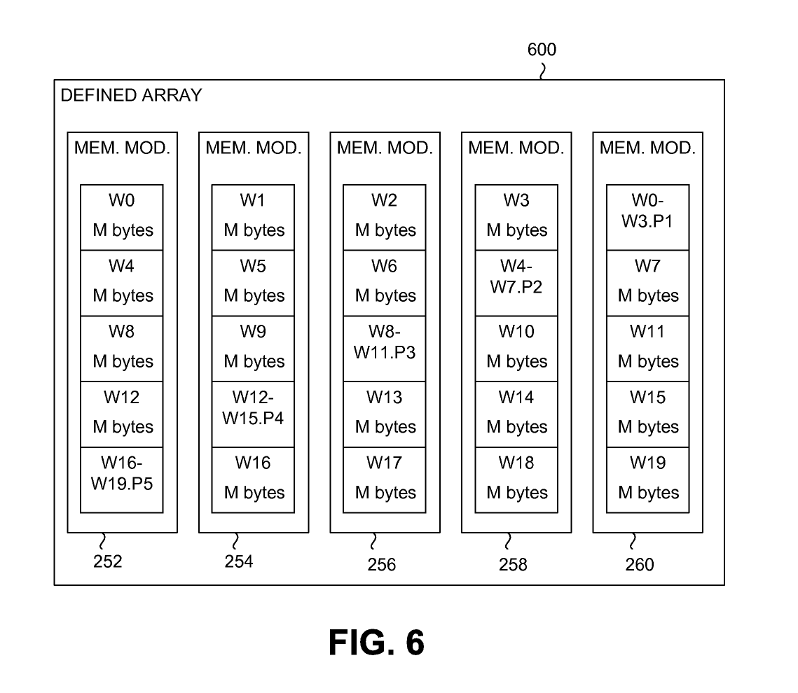

FIG. 6 illustrates a block diagram of an embodiment of a defined array 600 that supports the storage of a second data type, i.e., write operations, from the storage controller 200 of FIG. 2. As indicated in FIG. 6, the defined array 600 is supported by N separately addressable and otherwise independent data storage elements labeled “MEM. MOD.” or memory module. As indicated, the N separately data storage elements may be flash-based elements provided in one or more integrated circuits or separately addressable solid-state storage drives. Although the illustrated embodiment includes five such separately addressable data storage elements, arranged as memory module 252, memory module 254, memory module 256, memory module 258, and memory module 260, it should be understood that alternative embodiments with as few as three separately addressable data storage elements or with as many separately addressable data storage elements as may be required to achieve a desired total cache store capacity with a set of commonly available storage elements may be included in the defined array 600.

As further illustrated in FIG. 6, the memory module 252 is divided into a sequentially ordered series of blocks or strips each having a capacity of M bytes. The sequentially ordered series of blocks or strips include a first sub-element or strip labeled “W0” followed by “W4,” “W8,” W12,” and “W16-W19.P5.” While not arranged in a straight sequence such as 1, 2, 3, 4, 5, the corresponding data associated with the labeled write operations are designated to be stored in this first memory module 252 of the defined array 600 are in a sequential order in that W4 follows W0, W8 follows W4, and W12 follows W8.

Unlike the previous defined arrays illustrated in FIGS. 4 and 5, which included arrangements for storing line fill operations, a parity stripe is located in registration with each row of the defined array 600. For example, a parity strip labeled W0-W3.P1, corresponding with write operations W0 through W3 that are designated for storage across the first sub-element of each of the memory modules 252-258, is located in the corresponding first strip of memory module 260. A respective parity strip designated for corresponding write operations of subsequent stripes moving from top to bottom of FIG. 6 are shifted one memory element to the left. Thus, each stripe is protected by a parity strip, which can be used to regenerate the data in any one of the strips should that portion of the corresponding memory element used to store the strip fail for any reason. As indicated above, the parity calculation is implemented by performing an Exclusive-OR (XOR) logic operation over the data within the strips of a defined stripe only after write operations have filled each strip of the stripe.

The memory module 254 is similarly divided into a sequentially ordered series of blocks or strips each having a capacity of M bytes. The sequentially ordered series of blocks or strips include a first sub-element or strip labeled “W1” followed by “W5,” and “W9.” Thereafter, the memory element 254 includes a strip, labeled “W12-W15.P4” designated for storage of a parity strip for the fourth stripe followed by strip labeled “W16.”

The memory module 256 is also divided into a sequentially ordered series of blocks or strips each having a capacity of M bytes. The sequentially ordered series of blocks or strips include a first sub-element or strip labeled “W2” followed by “W6” Thereafter, the memory element 256 includes a strip, labeled “W8-W11.P3” designated for storage of a parity strip for the third followed by strips labeled “W13” and “W17.”

The memory module 258 is also divided into a sequentially ordered series of blocks or strips each having a capacity of M bytes. The sequentially ordered series of blocks or strips include a first sub-element or strip labeled “W3” followed by a strip, labeled “W4-W7.P2” designated for storage of a parity strip for the second stripe, followed by strips labeled “W10,” “W14” and “W18” in that order.

The memory module 260 is divided into a sequentially ordered series of blocks or strips each having a capacity of M bytes. The sequentially ordered series of blocks or strips include a first sub-element or strip, labeled “W0-W3.P1” and designated for storage of a parity strip for the first stripe, followed by strips labeled “W7,” “W11,” “W15” and “W19” in that order.

When the capacity in bytes of the memory module 260 exceeds the product of the number of write operations and M bytes, this pattern or other patterns may be repeated across a desired number of sub-elements or strips until the assigned storage capacity of the separately addressable memory modules 252-260 in total reaches a desired capacity of the cache store or the capacity of the N memory modules is exhausted. It should be understood that the parity strips distributed across the N memory modules do not contribute to the total data storage capacity of the cache store when used for that purpose.

FIG. 7 illustrates a schematic diagram of a series of data storage operations for storing data from a stream of data including both the first type (line fill) and the second type (writes) in the cache store 250 of FIG. 2. The uppermost portion of the illustration shows an example series of operations corresponding to the storage of an example data stream coupled with a corresponding strip selection and stripe allocation for designating a corresponding storage locations within the cache store 250. The lowermost portion of the illustration further shows how the example combination of data of the both the first type and the second type may be arranged in an embodiment of a defined array 700.

As indicated in the example, a controller coupled to the cache store 250 identifies when data originating in a primary data store is to be stored in the cache store. A first portion of such data comprising the first M bytes of a data stream received at the cache store 250 is identified as a first line fill operation labeled “Line Fill 1.” The data corresponding to the first line fill operation or OP 1 is processed by the cache store as indicated by the selection of a first stripe and a first element or strip of the first stripe for storage of the first M bytes.

A second portion of the data comprising the next M bytes of the data stream received at the cache store 250 is identified as a second line fill operation labeled “Line Fill 2.” The data corresponding to the second line fill operation or OP 2 is processed by the cache store by using the same stripe and a second element or strip of the first stripe for storage of the second M bytes.

Thereafter, a third portion of the data comprising the next M bytes of the data stream received at the cache store 250 is identified as a third line fill operation and labeled as “Line Fill 3.” The data corresponding to the third line fill operation or OP 3 is processed by the cache store 250 by using the same stripe and a third element or strip of the first stripe for storage of the third M bytes of the data stream.

A fourth portion of the data stream comprising the next M bytes is identified as a write operation. That is, this portion of the data stream received at the cache store 250 includes information that has not been written to the primary data store 140. As indicated in the illustration, the fourth portion of the data corresponding to the first write operation and labeled “Write 1” is processed by the cache store 250 by placing the same in the second or next available stripe, labeled “OP 4.”

A fifth portion of the data comprising the next M bytes of the data stream received at the cache store 250 is identified as a fourth line fill operation labeled “Line Fill 4.” The data corresponding to this fourth line fill operation or OP 5 is processed by the cache store 250 by using the next previous stripe that was previously populated with similar line fill data. As indicated in the illustrated embodiment, the data associated with this fifth data operation is stored in the fourth strip of the first stripe of the defined array 700.

A sixth portion of the data stream comprising the next M bytes is identified as a write operation. That is, this portion of the data stream received at the cache store 250 includes information that has not been written to the primary data store 140. As indicated in the illustration, the sixth portion of the data corresponding to the second write operation and labeled “Write 2” is processed by the cache store 250 by placing the same in the next available strip in the second stripe, labeled “OP 6.”

A seventh portion of the data stream comprising the next M bytes is identified as a write operation. That is, this portion of the data stream received at the cache store 250 includes information that has not been written to the primary data store 140. As indicated in the illustration, the seventh portion of the data corresponding to the third write operation and labeled “Write 3” is processed by the cache store 250 by placing the same in the next available strip in the second stripe, labeled “OP 7.”

An eighth portion of the data stream comprising the next M bytes is identified as a write operation. That is, this portion of the data stream received at the cache store 250 includes information that has not been written to the primary data store 140. As indicated in the illustration, the eighth portion of the data corresponding to the fourth write operation and labeled “Write 4” is processed by the cache store 250 by placing the same in the next sequentially available strip of memory module 260 and associating the same with the other write operations stored in the defined array 700. As indicated, upon receipt and storage of the N−1th write operation a parity strip can now be populated with an XOR operation being performed over the corresponding bits of the data stored in the strips associated with data transfer operations W1-W4. This ninth operation is performed in conjunction with the eighth data operation with the result of the XOR calculation being stored in the next sequentially available strip of the memory module 258. Note that this is the location identified for a parity strip in the second stripe of the defined array as arranged in the embodiment illustrated in FIG. 6.

FIGS. 8A and 8B illustrate a flow diagram of a method 800 for processing data with a storage controller. The method 800 begins with block 802 where a layout is defined for distributing data within a cache memory supported by solid state memory elements. As indicated above, an example layout will include segments distributed across the solid state memory elements so that data associated with line fill operations and write operations will be distributed in an ordered fashion with each subsequent write to a memory element performed in sequence. In addition, a parity block is identified for each stripe defined in the layout or defined array of segments. As also indicted above parity blocks are used for stripes that include data associated with write operations.

In block 804, a cache controller is initialized. This initialization may include the use of one or more parameters that are responsive to the layout defined in block 802. For example, such parameters may include the number of distinct flash-based memory elements or solid-state storage drives that are used to support the cache memory, the size of a block or strip of data to be stored to the respective memory elements or storage drives, a number of stripes, a location of a parity strip for each of the stripes, etc. These parameters will include a line fill count, a stripe identifier, and a write count.

In block 806, a data block is received at a cache interface. In decision block 808 it is determined if the content in the data block is already in a primary data store. When it is determined that the data block contains information that is already stored in the primary data store, as indicated by the flow control arrow labeled “Yes,” exiting decision block 808, processing continues with decision block 810, where it is determined whether a line fill stripe (LFS) is open. When a LFS is not open, as indicated by the flow control arrow labeled “No” exiting decision block 810, the method 800 continues with block 812, where the next unused stripe is selected and a line fill stripe flag is set. Otherwise, when the LFS flag is set (a line fill stripe is already partially filled with data), processing continues with block 814. In block 814, the received information associated with the data block or segment is stored in the layout in response to the line fill count and the stripe identifier. As further indicated in block 814, the stripe identifier is recorded or stored.

In decision block 816, a determination is made whether the stripe is filled with data associated with line fill operations. When this is the case and when a write stripe is not already started processing continues with block 822 where the stripe identifier is incremented. When the stripe is filled with data associated with line fill operations and a write stripe is already open, as indicated by the flow control arrow labeled “Yes” exiting decision block 818, processing continues with block 820, where the next unused stripe identifier is selected for use. In block 824, the line fill count is reset.

Otherwise, when the stripe is not filled with data associated with line fill operations, as indicated by the flow control arrow labeled “No” exiting decision block 816, processing continues with block 826, where the line fill count is incremented. In decision block 828, a determination is made whether to continue to store data in the cache store. When the decision is to continue, the method 800 returns to the functionality associated with decision block 808. Otherwise, the method 800 terminates.

When it is determined that the content in the received data block has not been stored in a primary data store, the functions illustrated in blocks 810 through 828 are bypassed, as indicated by the flow control arrow labeled “No” exiting decision block 808 and connector A. When this is the case, processing continues with decision block 830 (FIG. 8B) where it is determined if a write stripe is open. When a write stripe is not open, as shown by the flow control arrow labeled “No exiting decision block 830, the method 800 selects the next unused stripe and sets the write stripe flag, as indicated in block 832. Otherwise, when a write stripe is already in use, as indicated by the flow control arrow labeled “Yes” exiting decision block 830, processing continues with block 834 the information received at the cache interface is stored in response to the write count and in sequential order for the respective memory module. In addition, the stripe identifier is recorded.

Thereafter, in decision block 836, a determination is made whether the write count is one less than the number of distinct flash-based memory elements or solid-state storage drives supporting the cache store. When the write count is not equal to one less than the number of memory elements, as indicated by the flow control arrow labeled “No” exiting decision block 836, the functions illustrated in blocks 838 through 846 are bypassed.

Otherwise, method 800 continues with decision block 838 where it is determined whether a line fill stripe is open. When a line fill stripe is not open, the method 800 increments the stripe identifier as shown in block 842. Otherwise, when a line fill stripe is open, the method 800 sets the stripe identifier to the next unused stripe, as indicated in block 840. Thereafter, processing continues with block 844, where a parity block is computed based on the contents of the stored information in the write operation stripe and the parity information stored in the strip designated for such storage within the present stripe. Note that when the parity strip for the previous stripe is not yet filled with data the parity information may be stored in the available segment associated with the previous stripe. Next, as indicated in block 846, the write count is reset. In block 848 the write count is incremented. In decision block 850, a determination is made whether to continue to receive and store data in the cache store. When the response to the determination is that processing should continue, as indicated by the flow control arrow labeled “Yes” exiting decision block 828 and connector B, processing continues with block 806 (FIG. 8A). Otherwise, the method 800 for processing data with a storage controller terminates, as shown by the flow control arrow labeled “No” exiting decision block 850.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or in parallel (substantially simultaneously) with other steps without departing from the scope of the invention. In some instances, certain steps may be omitted or not performed without departing from the invention. Further, words such as “thereafter”, “then”, “next”, “subsequently”, etc. are not intended to limit the order of the steps. These words are simply used to guide the reader through the description of the exemplary method. For example, the functions associated with block 844 and block 846 can be performed substantially simultaneously or in reverse sequence from that shown in FIG. 8B.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention.

In one or more exemplary aspects as indicated above, the functions described may be implemented in hardware, software, firmware, or any combination thereof. If implemented in software, the functions may be stored as one or more instructions or code on a computer-readable medium, such as a non-transitory processor-readable medium. Computer-readable media include data storage media.

A storage media may be any available media that may be accessed by a computer or a processor. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of non-transitory computer-readable media.

Although selected aspects have been illustrated and described in detail, it will be understood that various substitutions and alterations may be made herein without departing from the present systems, methods and computer-readable storage media, as defined by the following claims.

1. A method for operating a cache memory supported by solid-state data storage modules, the method comprising:
defining a layout for distributing data in a cache memory supported by N solid-state memory elements, where N is an integer;
initializing, in a cache controller, a line fill count and a write count;
receiving a data block in a cache interface, the contents of the data block designated for storage in the cache memory;
determining, in a cache controller, if the content of the data block is presently stored in a primary data store coupled to the cache interface or if the content is from a host system in anticipation of a subsequent transfer to the primary data store; and
when the content of the data block is presently stored in the primary data store,
storing the data block in the cache memory in response to the line fill count and incrementing the line fill count,
otherwise,
storing the data block in the cache memory in response to the write count and incrementing the write count.

2. The method of claim 1, wherein data stored in the cache memory is sequentially arranged in each respective solid-state module.

3. The method of claim 1, further comprising:
determining when the line fill count is N; and
incrementing a first stripe count and reinitializing the line fill count.

4. The method of claim 1, further comprising:
storing the N−1^{th} data block;
determining when the write count is N−1;
computing a parity block responsive to the N−1 data blocks that have been received and stored in the cache memory but not transferred to the primary data store;
incrementing a second stripe count and reinitializing the write count; and
storing the parity block.

5. The method of claim 4, wherein storing the parity block includes locating the parity block in accordance with the layout and storing the N−1^{th} data block includes locating the data block in the next available strip in the N^{th} solid-state data storage module.

6. The method of claim 4, further comprising:
receiving a subsequent data block in the cache interface; and
repeating the determining and storing steps of claim 1.

7. A data storage system, comprising:
a cache memory supported by N solid-state storage modules, where N is an integer; and
a controller coupled to the cache memory, the controller including processing logic that is configurable to define and manage data transfers to and from the cache memory, the data transfers as managed by the controller including successive line fill operations to designated solid-state storage devices distributed among the N solid-state storage elements in a defined manner.

8. The data storage system of claim 7, wherein data stored in the cache memory is sequentially arranged in each respective solid-state module.

9. The data storage system of claim 7, wherein the data stored in the cache is not exposed to host applications.

10. The data storage system of claim 7, wherein the N solid-state storage modules are logically divided into a first set of addressable strips.

11. The data storage system of claim 7, wherein N is an integer greater than two.

12. The data storage system of claim 7, wherein one of the N solid-state modules includes a strip designated to store parity information for a stripe.

13. The data storage system of claim 7, wherein the controller computes a parity block responsive to n−1 write blocks that have been received and stored in the cache memory by performing an Exclusive-Or (XOR) operation on the n−1 write blocks.

14. The data storage system of claim 7, wherein the N solid-state modules are coupled to the controller via dedicated interfaces.

15. The data storage system of claim 7, wherein the N solid-state modules are integrated on a printed circuit.

16. The data storage system of claim 7, wherein the data transfers further include write operations to a second set of addressable strips different from the first set of addressable strips.

17. The data storage system of claim 16, wherein parity information for a stripe of write operations is calculated only after buffered data present in the cache is greater than or equal to a capacity equivalent to an amount of data that can be stored in a full-stripe write operation.

18. A computer-readable medium having stored thereon, in computer executable non-transitory form, instructions that, when executed on a processing system of a data storage controller, direct the data storage controller to:
identify when a data block designated for storage in a cache memory, supported by N solid-state storage modules, where N is an integer, is presently stored in a primary data store coupled to the cache memory; and
when the content of the data block is presently stored in the primary data store,
locate the data block in the cache memory in response to a line fill count,
otherwise,
locate the data block in the cache memory in response to a write count, wherein each data block is placed in a defined logically sequential order within each respective solid-state storage module.

19. The computer-readable medium of claim 18, wherein the N solid-state storage modules are logically divided into respective sets of addressable strips designated for the receipt of cache line fill operations and the receipt of write block operations.

20. The computer-readable medium of claim 19, wherein the sets of addressable strips include a strip designated to store parity information for a stripe upon receipt of a N−1^{th} data block with data responsive to write block operations.
